(19) United States
(12) Patent Application Publication
(10) Pub. No.: US 2011/0109112 A1
(43) Pub. Date: May 12, 2011

(54) STEERING ASSEMBLY FOR A VEHICLE

(75) Inventors: Thomas JENNY, Alsbach-Hahnlein (DE); Ulrich RICK, Braunweiler (DE)

(73) Assignee: GM GLOBAL TECHNOLOGY OPERATIONS, INC., Detroit, MI (US)

(21) Appl. No.: 12/883,104

(22) Filed: Sep. 15, 2010

(30) Foreign Application Priority Data
Sep. 16, 2009 (DE) 102009041714.1

(51) Int. Cl. B60R 13/02

(52) U.S. Cl. 296/1.08

(57) ABSTRACT

An assembly is provided for a vehicle that includes, but is not limited to having a steering assembly and at least one trim element that is removably connected to the steering assembly.

### CROSS-REFERENCE TO RELATED APPLICATION

This application claims priority to German Patent Application No. 102009041714.1, filed Sep. 16, 2009, which is incorporated herein by reference in its entirety.

### TECHNICAL FIELD

The invention relates to steering assembly for a vehicle having a steering device, having at least one paneling element, and having an airbag module.

### BACKGROUND

Steering assemblies for vehicles, in particular for automobiles, are well known. Such a steering assembly typically comprises a steering device, which is preferably implemented as a steering wheel. The steering device allows the vehicle to be controlled and/or steered. Steering wheels are especially known which consists of a base structure, in particular a steering wheel framework, and a trim element, in particular a steering wheel framework casing.

The publication EP 1 442 957 B1 discloses a steering wheel for vehicles, which has a base structure and at least one outer cover element, which is attached to the base structure. The publication DE 1 914 962 U discloses a steering wheel wrapper in the form of a strip ring made of a material, which is elastically deformable in the longitudinal direction and expediently also in the transverse direction, such as textile, rubber, or plastic. When it is stretched on the wheel rim, the steering wheel wrapper forms a hollow profile similar to a hose and is provided on the interior with a cushion. The publication DE 10 2006 055 488 A1 describes an adaptive operating element for a vehicle. The operating element is manufactured from a flexible material, which is suitable for being adapted to a curved surface in such a manner that the operating element presses in a formfitting manner against the curved surface. The operating element can preferably be attached on a spoke of a steering wheel. The publication DE 102 006 041 386 A1, which is considered to form the most similar prior art, discloses a steering wheel for a vehicle and a method for the production thereof. The steering wheel comprises a steering wheel framework having a hub body, a steering wheel collar, and at least one spoke, the at least one spoke connecting the hub body to the steering wheel collar. The steering wheel framework is at least partially encased using a casing. A textile material can be provided as the casing.

In view of the foregoing, at least one object is to fashioning a vehicle interior in a function and design oriented manner. In addition, other objects, desirable features, and characteristics will become apparent from the subsequent summary and detailed description, and the appended claims, taken in conjunction with the accompanying drawings and this background.

### SUMMARY

According to an embodiment of the invention, a steering assembly is proposed, which is integrated and/or integratable in a vehicle, preferably in an automobile. The steering assembly has a steering device, which is suitable and/or implemented for the purpose of allowing control and/or steering of the vehicle. The steering device can be implemented as a steering lever, a handlebar, or a steering knob. The steering device is preferably implemented as a steering wheel. The steering wheel typically has a steering wheel collar, via which a steering movement of the driver is typically transmitted to the steering assembly. Furthermore, the steering wheel has at least one steering wheel spoke and a hub area, the at least one steering wheel spoke connecting the steering wheel collar to the hub area. The steering device is optionally formed from plastic and/or metal.

The steering assembly has at least one trim element. The trim element preferably at least regionally encloses and/or covers the steering device in a formfitting manner. The trim element preferably envelops the entire area of the steering device. In particular, it can entirely or partially cover the steering device. The trim element preferably envelops the entire surface of the steering device. It is also conceivable that the trim element encloses and/or conceals the steering device over its entire area with interruptions. For example, the trim element encloses and/or envelops the steering device in a raster.

The steering assembly comprises an airbag module, which is preferably situated in the steering device, in particular in the hub area of the steering wheel. The airbag module is typically implemented as a driver front airbag and/or ring airbag and has, for example, a design in the form of a container and/or pot. The airbag module comprises an opening area, at least one airbag, and at least one gas generator. The airbag is suitable and/or implemented for the purpose of filling with gas from a gas generator and opening through the opening area in the direction of a vehicle driver in the event of an activation, for example, due to an impact of the vehicle.

According to an embodiment of the invention, the at least one trim element is detachably connected to the steering assembly. For this purpose, the trim element can be connected to the steering device and/or to the airbag module. In particular, the trim element is suitable and/or implemented for the purpose, in the installed state of the steering assembly, of being removed there from and/or replaced without damage and/or destruction. In particular, reinstallation of the trim element is possible after the removal.

At least one advantage of the invention is that the trim element can be exchanged cost-effectively and rapidly. This is necessary and desirable in particular in the event of soiling and/or damage of the trim element.

In a preferred embodiment of the invention, the trim element is removable from the steering assembly without tools. In particular, the connection between trim element and steering assembly can be disengaged by one or a few simple actions. The disengagement of the connection can especially also be performed by untrained individuals. Costs for corresponding repair shop jobs may thus advantageously be saved.

The trim element is optionally locked with the steering assembly and/or hooked in the steering assembly. A snap connection between the trim element and the steering assembly is also conceivable. It is also possible that the trim element is screwed onto the steering assembly.

A preferred embodiment of the invention provides that the trim element is suitable and/or implemented for the purpose of being replaced by another and/or a different type of trim element. In particular, the trim element can be replaced by a new trim element in the event of damage and/or soiling. The trim element can preferably also be replaced by a trim element which has a different look and/or feel and/or a different design.

The exchangeability of the trim element has the advantage that upon purchase of the vehicle, special customer wishes with respect to the design, the material, and/or the color of the trim element may be fulfilled, because they are arbitrarily exchangeable with little outlay. If the taste and/or the ideas of the customer change after the purchase of the vehicle, it is also possible in the “aftermarket business” to meet the new wish of the customer and replace an existing trim element with another one. It is particularly advantageous that the possibility exists for each customer of attaching a different trim element to the steering assembly depending on his individual taste himself, with few actions and without risking damage to the steering assembly.

In another embodiment of the invention, the trim element comprises a rigid component, such as a hard plastic, as the carrier structure.

A preferred embodiment of the invention provides that the trim element is entirely or partially covered using a cover. The carrier structure of the trim element is preferably covered using the cover. In particular, the cover is implemented as a decorative surface and/or as a design element.

It is conceivable that the cover covers the trim element continuously and/or without interruptions. The cover preferably covers the entire area of the trim element. Combinations of the above-mentioned possibilities are also conceivable.

Optionally, the cover can cover the trim element over its entire area with interruptions. For example, the cover covers the trim element in a raster. In particular, the cover covers the trim element in a regular and/or irregular pattern.

However, it is also conceivable that the cover covers the trim element in the form of one or more patterns, characters, symbols, images, letters, and/or inscriptions. However, it is also possible that the trim element has subareas which do not comprise a cover.

The cover preferably has a color design, the cover being able to be implemented as monochrome or multicolored. The cover is optionally implemented as patterned and/or it has finishing elements, which are applied to the cover.

It is advantageous that through the covering of the trim element with a cover, a new image-shaping design feature can be introduced into a vehicle interior. Through different variants of the cover, it is possible to adapt the material and/or color of the steering assembly to the remaining vehicle interior. In particular, the look and/or the feel of the steering assembly can be improved. Furthermore, it is advantageous that through the combination of the cover and the removable trim element, individual customer wishes can also be met in the “aftermarket business”. The design in the vehicle interior can thus also be changed after the purchase of an automobile. It is also noteworthy that lacquering of the steering device can be dispensed with in areas having trim elements. It is thus possible to dispense with an additional manufacturing step and save costs.

In a preferred implementation of the invention, the cover is applied directly to the trim element. The cover is preferably attached and/or fastened without an intermediate layer on the trim element. In particular, the cover covers the trim element without an intermediate layer. It can thus be stretched over the trim element and/or be attached to the trim element by another suitable method and/or technique.

In another embodiment, the cover is applied to the trim element indirectly having one or more intermediate layers. The cover preferably has a carrier film and/or a coating and/or is connected thereto. In particular the carrier film and/or the coating are situated on a side facing toward the trim element. For example, the carrier film and/or the coating comprise a barrier layer and/or a composite material, which is preferably materially bonded to the trim element. The connection can optionally also be performed by in-mold decorating, gluing, laminating, and/or by thermal heat introduction, such as welding, lasers, etc., or by another suitable joining method.

In a preferred embodiment, the cover comprises a textile material. The textile material preferably comprises woven fabric, knitted fabric, and/or scrim fabric. The textile material preferably has natural and/or artificial components, such as animal and/or vegetable fibers, chemical and/or artificial fibers and/or mineral fibers. In particular, the textile material is formed from cotton, viscose, silk, and/or polyester. The textile material is optionally suitable and/or implemented for the purpose of forming a planar formation. It can thus be implemented, for example, as a fabric, cloth, felt, and/or nonwoven. The textile material can also comprise fluffy fibers in an optional implementation.

In a further embodiment of the invention, the cover comprises a film and/or a lacquer layer. It is also conceivable that the trim element, in particular the carrier structure, is colored. The carrier layer preferably forms the decorative layer in this embodiment.

In a further embodiment of the invention, the cover is adapted and/or tailored in look or feel to further covers of a vehicle interior and/or to a design of bodywork of the vehicle and/or implemented identically thereto. The invention can also relate to a vehicle interior having the steering assembly. The vehicle interior typically comprises equipment elements, such as door inner panels, seat coverings, a dashboard, etc. The cover preferably has similar and/or identical patterns, colors, surface structures, etc. as the equipment elements and/or the bodywork. In particular, the cover can have the same pattern and a different color as the equipment elements, or, for example, the same color and a different pattern. Optionally, the cover can have symbols from a marketing campaign, for example, which are located on and/or at the equipment elements of the vehicle interior and/or on the bodywork of the vehicle.

A further embodiment of the invention provides that the trim element is formed by a steering wheel collar cover. The steering wheel collar cover preferably at least partially encloses and/or envelops and/or conceals the steering wheel collar. The steering wheel collar cover is particularly situated on an inner side of the steering wheel collar, the inner side being oriented toward the hub area. The steering wheel collar cover advantageously improves a look and/or feel during the steering movement.

In a further embodiment of the invention, the trim element is formed by a steering wheel spoke cover. The steering wheel spoke cover covers and/or encloses and/or envelops a steering wheel spoke framework. The steering wheel spoke cover and the steering wheel spoke framework form a steering wheel spoke, which typically connect the steering wheel collar to a steering wheel hub.

In a further embodiment, the trim element is formed by a cap trim. The cap trim is preferably removably integrated on the airbag module. In particular, the cap trim is connected to the airbag module in such a manner that it can be removed from the airbag module and installed again without damage and without impairing an airbag function. In a preferred implementation, the cap trim forms a unit and/or a rigid module surface with the airbag module. This implementation allows in particular a floating horn honking functionality.

Optionally, it is possible that the cap trim entirely or partially covers the hub area and/or the airbag module.

In a further embodiment of the invention, the trim element can also cover the steering wheel spokes in addition to the steering wheel collar and/or the airbag module, or can extend up to steering wheel spokes. The trim element optionally entirely or partially covers the steering wheel spokes. In particular, electrical operating elements possibly situated on the steering wheel spokes, such as switches and/or levers for controlling a radio, an air conditioner, and/or a navigation system, are not covered by the trim element. Combinations of the above-mentioned possibilities are also conceivable.

It is advantageous that a visual and/or tactile adaptation of the steering wheel collar to the airbag module can be performed. However, it is also possible to provide an intentionally designed difference in the look and/or the feel between steering wheel collar and airbag module, in that differently implemented trim elements may be selected for each of these components.

In a further possible embodiment, the steering assembly also comprises, in addition to nondestructively removable trim elements, trim elements which are not removably situated. It is thus conceivable, for example, that only the cap trim can be removed nondestructively and the steering wheel collar cover is not situated removably.

In a further embodiments, at least two trim elements have identical covers. The covers preferably have an identical design and/or an identical color styling and/or an identical pattern. It is also conceivable that at least two trim elements are colored similarly and/or identically.

In a further embodiment of the invention, at least two trim elements have different covers. Preferably, one trim element has the textile material and a further trim element has a film and/or lacquer coating. It is also conceivable that one of the trim elements has no cover, but rather a pigmented carrier material. Color, material, and/or tactile contrasts may thus be intentionally made possible on the steering device.

### BRIEF DESCRIPTION OF THE DRAWINGS

The present invention will hereinafter be described in conjunction with the following drawing figures, wherein like numerals denote like elements, and:

FIG. 1 shows a top view of a steering assembly having a steering device;

FIG. 2 shows a top view of the steering device from FIG. 1 without trim elements;

FIG. 3 shows a section X-X through the steering device from FIG. 1;

FIG. 4 shows a top view of a cap trim from the steering assembly from FIG. 1;

FIG. 5 shows a top view of an alternative cap trim from FIG. 4; and

FIG. 6 shows a top view of an alternative airbag module 6 of the steering device from FIG. 1.

### DETAILED DESCRIPTION

The following detailed description is merely exemplary in nature and is not intended to limit application and uses. Furthermore, there is no intention to be bound by any theory presented in the preceding background or summary or the following detailed description.

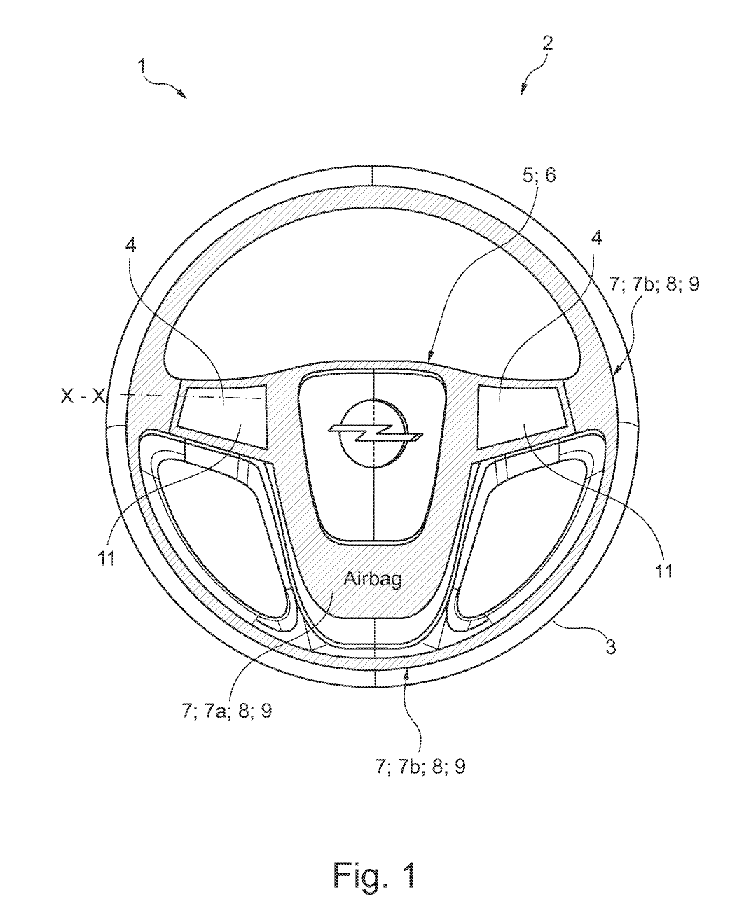

FIG. 1 shows a top view of a steering assembly 1 for a vehicle, in particular for an automobile. The steering assembly 1 comprises a steering device 2. The steering device 2 is implemented as a steering wheel for controlling and/or steering a vehicle. The steering device 2 has a steering wheel collar 3, two steering wheel spokes 4, and a hub area 5. The steering wheel collar 3 is suitable and/or implemented for the purpose of transmitting steering movements of a vehicle driver to the steering assembly 1. The steering wheel spokes 4 connect the steering wheel collar 3 to the hub area 5, which is situated in the center of the steering device 2.

The steering assembly 1 further comprises an airbag module 6, which is situated in the hub area 5. The airbag module 6 is implemented in the form of a container and/or pot and comprises at least one airbag and at least one gas generator. It additionally has an opening area, which is suitable and/or implemented for the purpose of providing an opening function upon an activation of the airbag module 6, for example, in the event of an impact of the vehicle. It is thus made possible for the at least one airbag to exit from the airbag module and unfold in the direction of the vehicle driver.

The steering assembly 1 has two trim elements 7. The trim elements 7 partially cover and/or enclose and/or envelop the steering assembly 1, in particular the steering device 2.

The trim elements 7 are implemented as a cap trim 7a and a steering wheel collar cover 7b. The cap trim 7a is situated in the outer area of the airbag module 6 and partially covers the airbag module 6 and the steering wheel spokes 4. The steering wheel collar cover 7b partially covers the steering wheel collar 3, in particular on an inner side facing toward the hub area 5, in an inner radius of the steering wheel collar 3.

The trim elements 7a, 7b are completely covered by a cover 8, which is used as a decorative surface or as a design element. The cover 8 comprises a textile material 9. The textile material 9 is formed by a fabric made of cotton and polyester. The cover 8 is directly applied to the trim elements 7, in particular without an intermediate layer. In particular, the cover 8 is stretched over the trim elements 7.

In an alternative exemplary embodiment of the invention, the cover 8 is applied to the trim elements 7 indirectly using one or more intermediate layers. The cover 8 comprises one or more intermediate layers, which are situated on a side facing toward the trim elements 7. The intermediate layer is materially bonded to the trim elements 7. The connection can be performed by in-mold labeling, laminating, gluing, or by thermal heat introduction, such as welding, lasers, etc. Furthermore, not all trim elements 7 have the same cover 8. One of the trim elements 7 has a cover 8 having a different color styling and/or made of a different material, such as a film coating 15 or a lacquer coating 16.

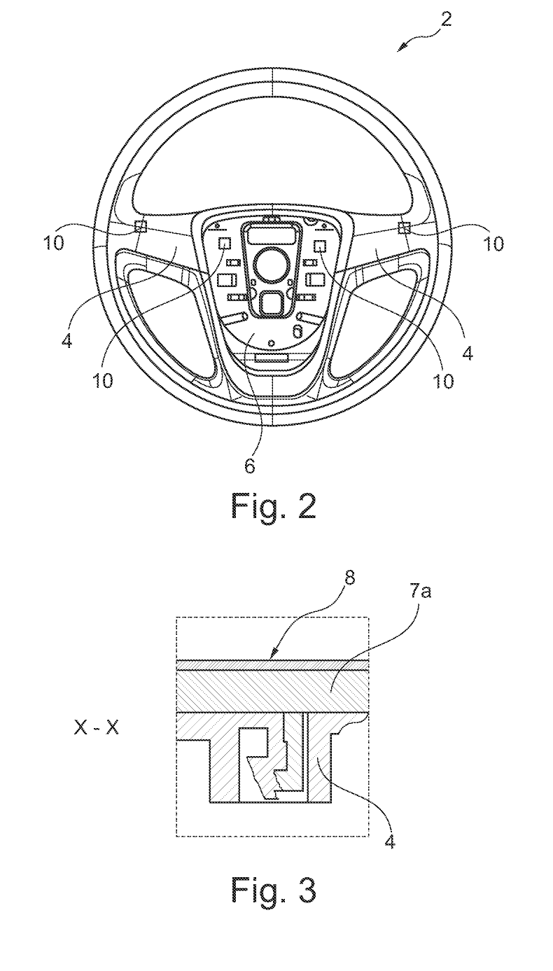

FIG. 2 shows the steering device 2 from FIG. 1 without trim elements, parts corresponding to one another or identical parts being provided with the same reference numerals in each case in the figures. Two fastening points 10 are situated on the steering wheel spokes 4 and the airbag module 6, which are implemented for the purpose of removably integrating the trim elements 7 on the steering device 2 and/or removably attaching them on the steering device 2.

FIG. 3 shows a section through the steering device 2 from FIG. 1 along section line X-X, parts corresponding to one another or identical parts being provided with the same reference numerals in each case in the figures. The cap trim 7a is removably hooked in the steering wheel spoke 4 and/or locked thereto. In an alternative exemplary embodiment of the invention, the cap trim 7a can also be screwed onto the steering wheel spoke 4 or fastened on the steering wheel spoke 4 using another suitable type of fastening. The cap trim 7a can thus be removed without damage from the steering wheel spoke 4 in the installed state of the steering device 1 and/or replaced at any time by another or a different type of cap trim 7b. The listed types of fastening are also applicable for all other trim elements 7 of the remaining figures at all other fastening points 10 of the steering device 2 from FIG. 2.

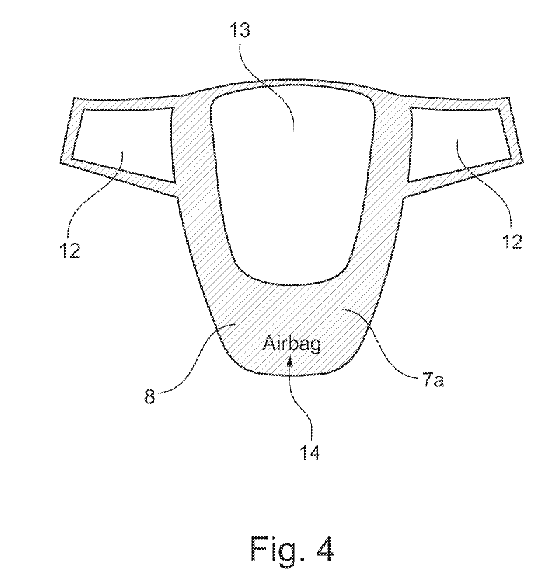

FIG. 4 shows a top view of one of the trim elements 7 from FIG. 1, which is implemented as the cap trim 7a. Parts corresponding to one another or identical parts are provided with the same reference numerals in each case in the figures. The cap trim 7a is suitable and/or implemented for the purpose of covering and/or disguising a part of the airbag module 6 and the steering wheel spokes 4. It extends from the airbag module 6 up to the steering wheel spokes 4, it leaving out a space 12 for situating electrical operating elements 11. An opening 13 is situated centrally and/or in the center of the cap trim 7a, which exposes a view of an undisguised area of the airbag module 6 after integration in the steering device 2. The cover 8 has a finishing element 14, which can be implemented as an embossed area, a sewn-on patch, an embroidered area, a sewn-in element, etc. The finishing element 14 has the inscription “airbag”.

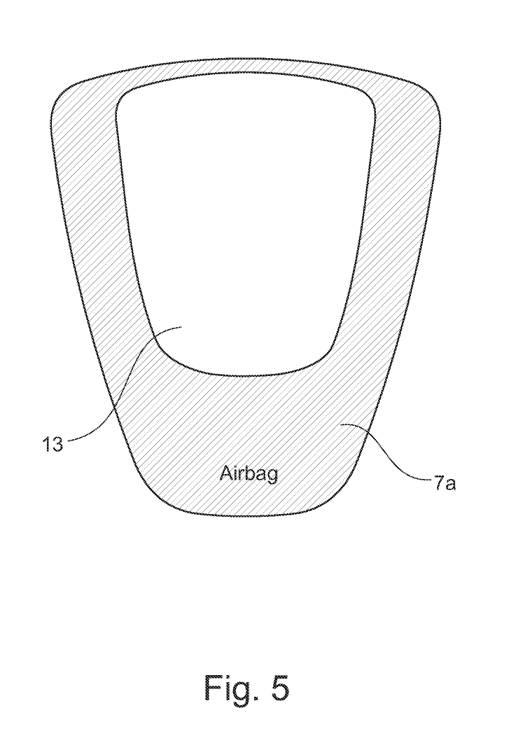

FIG. 5 shows a top view of an alteration of the cap trim 7a from FIG. 4, parts corresponding to one another or identical parts being provided with the same reference numerals in each case in the figures. This cap trim 7a is suitable and/or implemented for the purpose of partially covering the airbag module 6, in particular on the outer area of the airbag module 6. In the center, the cap trim 7a has the opening 13, in whose area the cap trim 7a does not cover the airbag module 6.

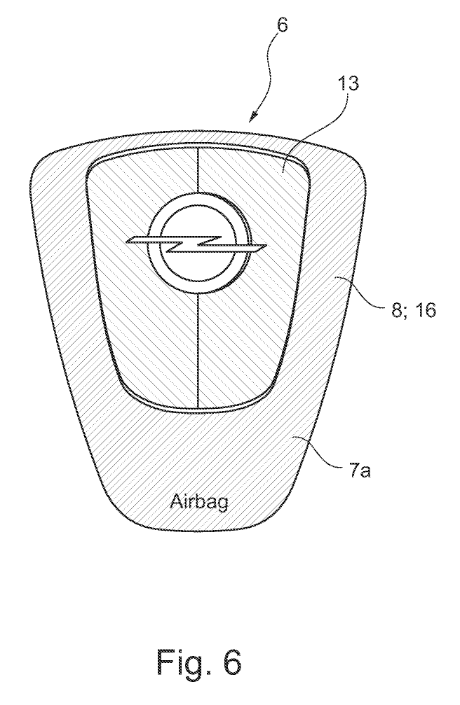

FIG. 6 shows a top view of an alteration of the airbag module 6 from FIG. 1. The trim element 7 is implemented as the cap trim 7a. It is removably connected to the airbag module 6 and forms a rigid module design surface, which ensures a “floating horn honking functionality”.

The cap trim 7a has the opening 13 in the center and exposes the view of the undisguised area of the airbag module 6. The undisguised area is implemented as lacquered. The trim element 7 has a cover 8, which comprises a lacquer coating 16. In an alternative exemplary embodiment of the invention, the trim element 7 can have a coloration using suitable colorants.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An assembly for a vehicle, comprising:
a steering assembly;
a trim element for the steering assembly; and
a removable connection for the trim element such that the trim element is removably connected to the steering assembly.

2. The assembly according to claim 1, wherein the trim element is adapted to be removable from the steering assembly without tools.

3. The assembly according to claim 1, wherein the trim element is adapted to lock with the steering assembly and/or is hooked in the steering assembly.

4. The assembly according to claim 1, wherein the trim element is adapted to hook in the steering assembly.

5. The assembly according to claim 1, wherein the removable connection is a screw.

6. The assembly according to claim 1, wherein a second trim element is adapted to replaced the trim element.

7. The assembly according to claim 1, wherein the trim element is at least partially covered with a cover.

8. The assembly according to claim 7, wherein the cover is directly attached to the trim element.

9. The assembly according to claim 7, wherein the cover is indirectly attached to the trim element using an intermediate layer.

10. The assembly according to claim 7, wherein the cover comprises a textile material.

11. The assembly according to claim 7, wherein the cover comprises a film layer.

12. The assembly according to claim 7, wherein the cover comprises a film layer.

13. The assembly according to claim 1, wherein the trim element comprises a partial coloration.

14. The assembly according to claim 1, wherein the trim element comprises a complete coloration.

15. The assembly according to claim 1, wherein the trim element is formed by a steering wheel collar cover.

16. The assembly according to claim 1, wherein the trim element is formed by a cap trim.

17. The assembly according to claim 6, wherein the second trim element is substantially identical to the trim element.

18. The assembly according to claim 6, wherein the second trim element is substantially different from the trim element.
